(19) United States
(12) Patent Application Publication
(10) Pub. No.: US 2007/0073797 A1
(43) Pub. Date: Mar. 29, 2007

(54) Recursive method for solving the inexact greatest common divisor problem

(75) Inventor: J. Andrew Johnson, Newark Valley, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Lockheed Martin Corporation

(21) Appl. No.: 11/238,619

(22) Filed: Sep. 29, 2005

(51) Int. Cl. G06F 7/38

(52) U.S. Cl. 708/446

(57) ABSTRACT

A method, system, and computer program product are provided for determining the greatest common divisor (GCD) for a plurality of data points. A plurality of interim solutions are generated from an initial set of at least one data point from the plurality of data points. An iterative algorithm is then performed until the occurrence of a termination event. The iterative algorithm includes selecting a new data point from the plurality of data points. Each of the plurality of interim solutions are updated according to the selected data point as to provide a set of at least one updated interim solution from each interim solution. Each updated interim solution is evaluated to produce a fitness parameter. An updated interim solution when the fitness parameter does not achieve a desired threshold.

### BACKGROUND OF THE INVENTION

1. Technical Field

The invention relates generally to data analysis methodologies and, more specifically, to systems and methods for solving the inexact greatest common divisor problem.

2. Description of the Prior Art

The greatest common divisor (GCD) problem was first solved for exact values (e.g., values without random noise) by Euclid as an iterative algorithm around 300 B.C. In Euclid's algorithm, the GCD can be determined by dividing the larger number by the smaller to obtain a remainder value. If the remainder is zero, the GCD is the smaller of the two numbers. If the remainder is non-zero, the problem is repeated for the smaller number and the remainder. This continues through a number of iterations until a remainder of zero is achieved. The GCD is the divisor used to achieve the remainder of zero.

The problem is complicated significantly by the introduction of noise into the values. Unfortunately, most real world applications require the capacity to analyze noisy data. Several limited solutions have been found to the inexact GCD problem, but they generally are useful only in certain circumstances, such as small data sets or data sets having only a moderate level of noise. These limitations make existing solutions inefficient for some applications.

### SUMMARY OF THE INVENTION

In accordance with one aspect of the present invention, a method is provided for determining the greatest common divisor for a plurality of data points. A plurality of interim solutions are generated from an initial set of at least one data point from the plurality of data points. An iterative algorithm is then performed until the occurrence of a termination event. The iterative algorithm includes selecting a new data point from the plurality of data points. Each of the plurality of interim solutions are updated according to the selected data point as to provide a set of at least one updated interim solution from each interim solution. Each updated interim solution is evaluated to produce a fitness parameter. An updated interim solution when the fitness parameter does not achieve a desired threshold.

In accordance with another aspect of the present invention, a system is provided for determining a greatest common divisor for a plurality of numerical data points. A system memory stores a pool of at least one interim solution. A solution updater updates the pool of interim solutions according to a received data point to produce at least one updated interim solution. A solution evaluator evaluates each updated interim solution and calculates an estimated GCD for each of the plurality of solutions. The solution evaluator eliminates an updated interim solution when the likelihood that the estimated GCD associated with the interim solution is correct falls below a threshold value.

In accordance with yet another aspect of the invention, a computer program product, encoded on a computer readable medium and operative in a computer processor, is provided for determining a greatest common divisor for a plurality of numerical data points. A system memory stores a pool of interim solutions. A solution updater receives a given data point from the plurality of numerical data points and updates the pool of interim solutions according to the received data point. A solution evaluator evaluates each updated interim solution to produce a fitness parameter and eliminates an updated interim solution when the fitness parameter does not meet a desired threshold.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a methodology for determining the greatest common divisor of a plurality of numerical data points having associated random noise in accordance with one aspect of the present invention.

FIG. 2 illustrates a decision tree representing a plurality of interim solutions to the greatest common divisor problem in accordance with an aspect of the present invention.

FIG. 3 illustrates an exemplary methodology for determining the greatest common divisor of a plurality of measurements containing random error in accordance with an aspect of the present invention.

FIG. 4 illustrates a second exemplary methodology for determining the greatest common divisor of a plurality of measurements containing random error in accordance with an aspect of the present invention.

FIG. 5 illustrates an exemplary system for determining the greatest common divisor of a sequence of data points containing random error in accordance with an aspect of the present invention.

FIG. 6 illustrates a schematic block diagram of an exemplary operating environment for a system configured in accordance with an aspect of the present invention.

### DETAILED DESCRIPTION OF THE INVENTION

In accordance with an aspect of the present invention, methods and systems for solving the inexact greatest common divisor problem are provided. The methods and systems can be applied to any of a number of applications in which an efficient, robust solution to the inexact greatest common divisor problem is desirable, such as the detection and location of radar emissions or the harmonic analysis of noisy data.

The present invention can be implemented, at least in part, as one or more software programs. Therefore, the structures described herein may be considered to refer either to individual modules and tasks within a software program or as an equivalent hardware implementation.

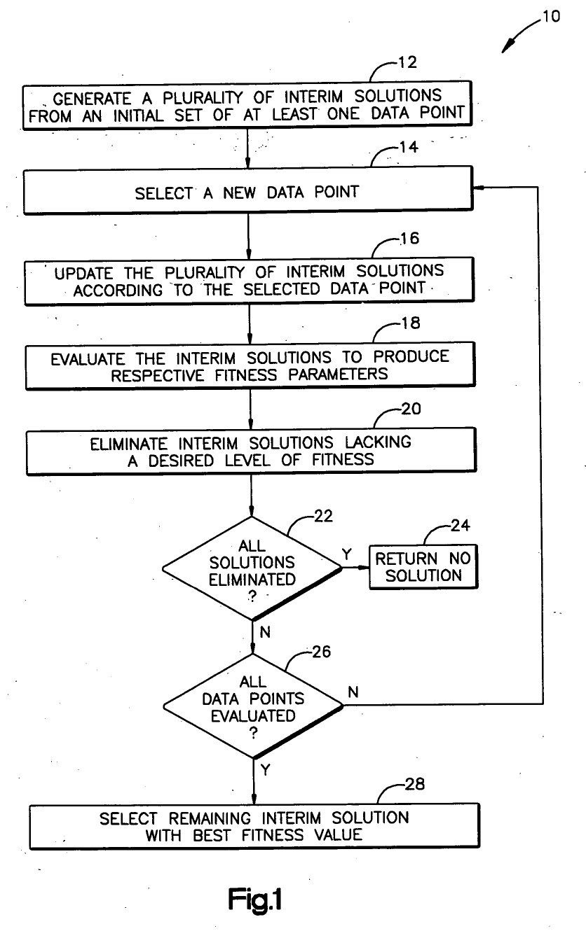

FIG. 1 illustrates a methodology 10 for determining the greatest common divisor (GCD) of a plurality of numerical data points having associated random noise in accordance with one aspect of the present invention. The methodology begins at block 12, where a plurality of interim solutions are generated from a set of at least one data point. Each interim solution can comprise a set of at least one integer multiplier associated with a given data point or linear combination of data points. For example, a range of possible values can be known for the GCD according to an associated application. The plurality of interim solutions can be generated by dividing a given data point, or a linear combination of data points, by associated minimum and maximum values from the range of possible values for the GCD.

At block 14, a new data point from the plurality of data points is selected. At block 16, the interim solutions are updated to incorporate another multiplier value based on the selected data point. For example, a range can be calculated from a previous estimate of the GCD and the selected data point, and a set of integers within the range can be determined. A new set of interim solutions can be generated from each existing interim solution, wherein each interim solution in a given set comprises the multiplier values comprising its associated existing interim solution and one of the plurality of integer values.

At block 18, each of the updated interim solutions are evaluated. For example, a regression analysis can be performed using the multiplier values associated with a given interim solution and the corresponding data points. A fitness parameter, such as the sum squared error, can be determined from each regression to determine the fitness of the solution. At block 20, interim solutions having a degree of fitness less than a desired threshold are eliminated from consideration. Eliminated solutions are not updated or evaluated when a new data point is added to the analysis. Accordingly, the processing demands associated with the methodology 10 is decreased over a brute force approach.

At decision block 22, it is determined if a termination event has occurred. For example, the termination event can include the achievement of a sufficiently small sum squared error, the elimination of all interim solutions but one, or the use of all available data points. If no termination event has occurred (N), the methodology returns to block 14 to select a new data point and update the remaining interim solutions. If a termination event has occurred (Y), the methodology advances to block 24, where the interim solution having the largest associated GCD estimate is selected.

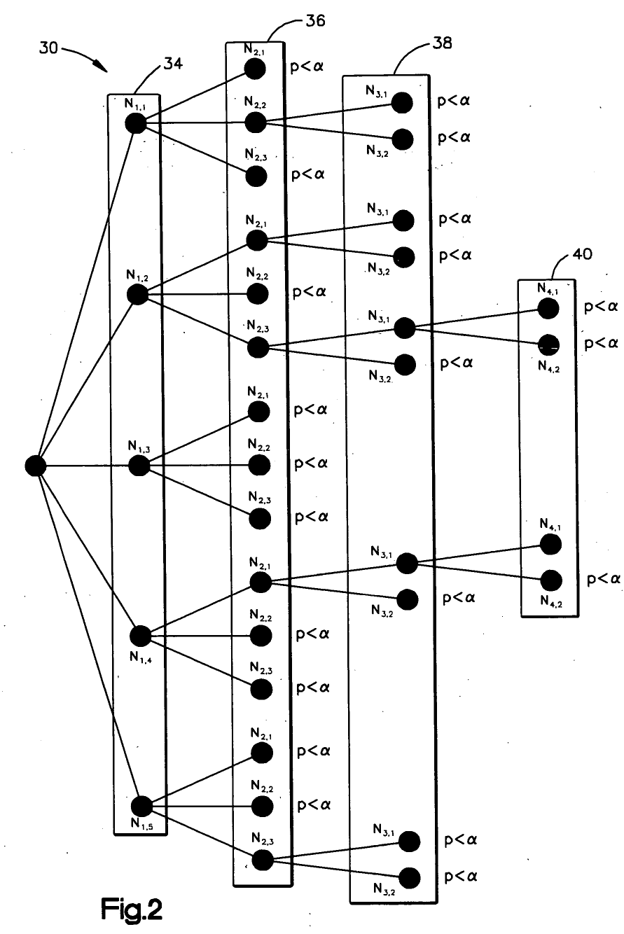

FIG. 2 illustrates a decision tree 30 representing a plurality of interim solutions to the greatest common divisor problem. The decision tree includes a root node 32 and a plurality of layers of branches 34, 36, 38, and 40. Each layer, 34, 36, 38, and 40 of the tree represents one of a plurality of data points used to generate the interim solution. A given node within each layer 34, 36, 38, and 40 represents a possible value for the integer multiplier associated with the data point represented by the layer. In the illustrated tree, the root node 32 does not represent a specific multiplier value, however, in some applications, the root node 32 can represent a default first multiplier value necessary for some data models.

The first layer 34 represents the initial interim solutions. The individual nodes represent a set of possible values for a first multiplier value, N₁. In a first iteration of a methodology associated with an aspect of the present invention, the initial interim solutions can be updated to add another layer 36 of possible multiplier values associated with a new data point. Each of the twelve paths from the root node 32 to a terminal node in the second layer 36 represents an interim solution to the GCD problem. The solutions can be evaluated to determine if they represent a likely answer to the problem, with solutions having an associated probability less than a threshold value, α, being eliminated from further updating and consideration.

In the third layer 38, a third data point is used to update the remaining interim solutions with a third set of multiplier values, and the updated solutions are evaluated. Again, solutions having associated probability values below the threshold probability, α, are eliminated. The fourth layer 40 represents the remaining solutions, updated with an additional set of multiplier values to incorporate a fourth data point. At this stage in the illustrated example, only one interim solution having an associated probability greater than the threshold remains. Accordingly, the remaining solution, comprising the set of multiplier values, [N_{1,4}, N_{2,1}, N_{3,1}, N_{4,1}], can be updated with any remaining data points and utilized to calculated the GCD of the data points.

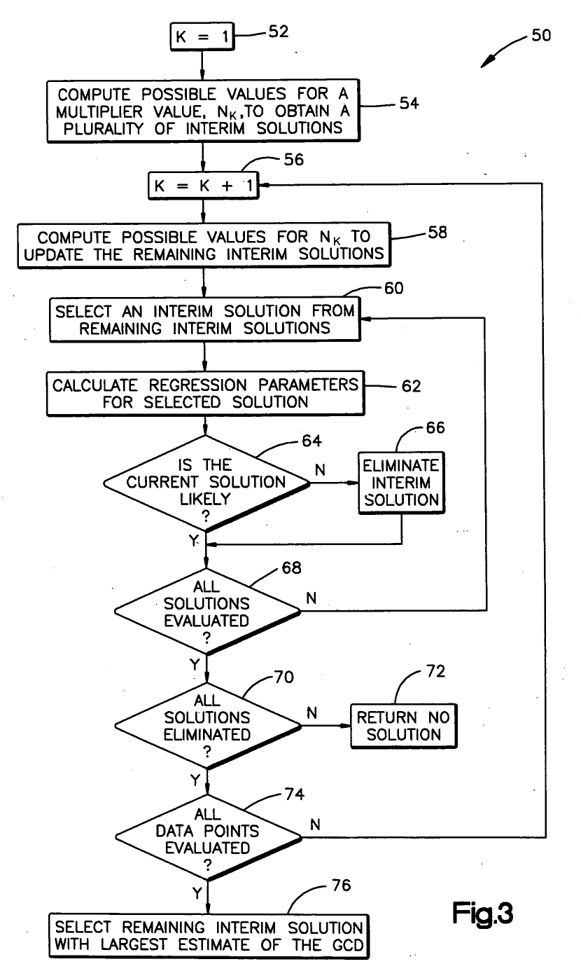

FIG. 3 illustrates an exemplary methodology 50 for determining the greatest common divisor (GCD) of a plurality of measurements containing random error. In the exemplary methodology 50, each of a plurality of data points received by the system is modeled as a multiple of the GCD with no offset and a random measurement error, such that:
tₖ=NₖT+Wₖ (Eq. 1)

where k is an index associated with the data points, tₖ is a k^{th} data point, T is the greatest common divisor for the data set, Nₖ is an integer multiplier associated with the k^{th} data point, and Wₖ is a random error from an Gaussian distribution having a mean of zero and a known variance σ².

Accordingly, the GCD can be determined as a slope associated with a line represented by the plurality of data points.

At block 52, the index, k, is initialized to one. At block 54, all possible values of N₁ are determined according to a known maximum value, Tₘₐₓ, and a known minimum value, Tₘᵢₙ, for T and the data point, t₁. For example, a set of possible values for N₁, can include all integers between a minimum value, t₁/Tₘₐₓ, and a maximum value, t₁/Tₘᵢₙ. At this point in the process, the set of possible values for N₁ can be conceptualized as a first branching for a decision tree representing a plurality of interim solutions to the greatest common divisor problem. Each interim solution is represented by the multiplier values along one of a plurality of paths from a root of the decision tree to an associated terminal branch. A first estimation of the slope, \hat{T}₀, can be determined for each value of N₁ as the ratio of the first data point, t₁, and N₁. A first estimate of the variance of the slope estimate, σ_{T}², can be determined for each possible value of N₁ as the ratio of the variance of the measurement errors, σ², and the square of the multiplier value, N₁.

The index k is incremented by one at block 56. The interim solutions are updated at block 58 using a set of all possible values for Nₖ. This can be accomplished by selecting all integer values within a defined range, such that:

$${N}_{k} ∈ \frac{\hat{T} {t}_{k} \pm \sqrt{{t}_{k}^{2} {\hat{T}}^{2} - ( {\hat{T}}^{2} - K {σ}_{T}^{2} ) ( {t}_{k}^{2} - K {σ}^{2} )}}{{\hat{T}}^{2} - K {σ}_{T}^{2}} \qquad ( Eq . 2 )$$

where k is an index associated with the data points, tₖ is a k^{th} data point, Nₖ is an integer multiplier associated with the k^{th} data point, K is a (1−α) quantile value associated with a desired confidence value, (1−α) in a chi-squared distribution, σ² is the variance associated with the measurement error, \hat{T} is the most current estimate of the slope of a line represented by the data points, σ_{T}² is the most current estimated variance associated with the slope estimate.

For large data sets, it can be assumed that the estimated variance of the slope σ_{T}² is roughly equal to the actual variance of the measurement errors, σ², and the calculation of the range simplifies to:

$${N}_{k} ∈ \frac{{t}_{k} \pm σ \sqrt{K}}{\hat{T}} \qquad ( Eq . 3 )$$

From the determined range, a new set of terminal branches associated with the possible values for the current multiplier value, Nₖ, can be appended onto the remaining branches of the decision tree. At black 60, an interim solution is selected from the available interim solutions.

At block 62, regression parameters can be calculated for the plurality of data points to estimate the GCD or a value associated with the GCD. The regression analysis can utilize the k ordered pairs, (Nₖ, tₖ), formed by the multipliers and data points that have been incorporated into the interim solutions. In an exemplary implementation, a correction value, T′, representing a correction for a previous estimated slope is determined to avoid large summed squared values that could reduce numerical precision of the calculation. The regression parameters can be calculated as:

$$\{ \begin{matrix}{S}_{xx} = {\sum }_{i = 1}^{k} {N}_{i}^{2} & {S}_{xy} = {\sum }_{i = 1}^{k} {N}_{i} Δ {t}_{i} & \\ Δ {t}_{i} = {t}_{i} - {N}_{i} {\hat{T}}_{0} & {T}^{′} = \frac{{S}_{xy}}{{S}_{xx}} & {σ}_{T}^{2} = \frac{{σ}^{2}}{{S}_{xx}} \\ {S}_{yy} = {\sum }_{i = 1}^{k} Δ {t}_{i}^{2} & k {E}^{2} = {S}_{yy} - {S}_{xy} {T}^{′} & \end{matrix} \qquad ( Eq . 4 )$$

where k is an index associated with the data points, tₖ is a k^{th} data point, Nₖ is an integer multiplier associated with the k^{th} data point, kE² is a summed squared error associated with the plurality of data points, σ² is the variance associated with the measurement error, \hat{T}₀ is a first estimate of a slope of a line represented by the data points, T′ is a correction value representing a present estimate, \hat{T}, of the slope, such that \hat{T}=T′+\hat{T}₀, and σ_{T}² is an estimated variance associated with the slope estimate.

The determined slope offset, T′, from the regression model allows an estimated GCD value to be determined for the interim solution, and the summed squared error, kE², provides an indication of the confidence in the solution.

At decision block 64, it is determined if the selected interim solution represents a likely solution for the GCD. A test value equal to the ratio of the summed squared error, kE², to the estimated variance of the measurement errors, σ², can be determined and compared to a chi-square distribution with (k−1) degrees of freedom. If the test value is determined to lie outside of a desired confidence interval within the chi-square distribution (N), the interim solution is eliminated from consideration at block 66. In terms of the decision tree model, the terminal branch associated with the interim solution is removed, such that no further updates are applied to the branch. The methodology then advances to decision block 68.

If it is determined at block 64 that the test value lies within the desired confidence value of the chi-square distribution (Y), the methodology advances directly to decision block 68. At block 68, it is determined if all of the interim solutions have been evaluated. If not (N), the methodology returns to block 60 to select a new interim solution for evaluation. If all of the interim solutions have been evaluated (Y), the methodology advances to decision block 70, where it is determined if a termination event has occurred. For example, the termination event can include the achievement of a sufficiently small sum squared error, the elimination of all interim solutions but one, or the use of all available data points. If no termination event has occurred (N), the methodology returns to block 66 to increment the index, k, and update the remaining interim solutions in light of the new data point. If a termination event has occurred (Y), the remaining interim solution having the largest associated slope value, T, is selected at block 62 to provide the GCD for the model, and the methodology terminates.

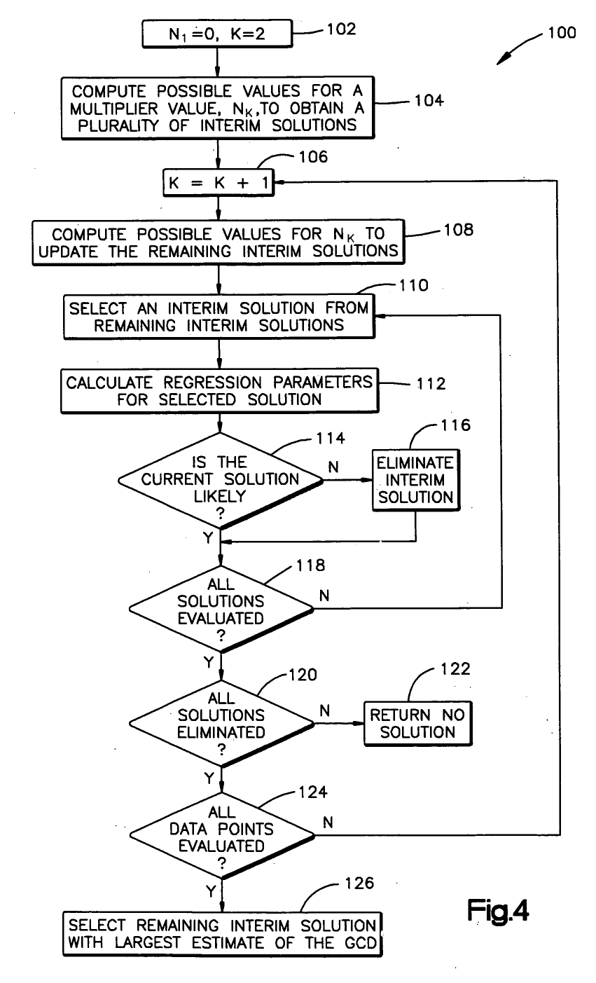

FIG. 4 illustrates a second exemplary methodology 100 for determining the greatest common divisor (GCD) of a plurality of measurements containing random error. In the exemplary methodology 100, each of a plurality of data points received by the system is modeled as a multiple of the GCD with an offset value that is constant across the plurality of data points and a random measurement error, such that:
tₖ=NₖT+T_{d}+Wₖ (Eq. 5)

where k is an index associated with the data points, tₖ is a k^{th} data point, T is the greatest common divisor for the data set, T_{d} is a constant offset value, Nₖ is an integer multiplier associated with the k^{th} data point, and Wₖ is a random error from an Gaussian distribution having a mean of zero and a known variance σ².

Accordingly, the GCD and the offset can be determined, respectively, as slope and intercept values associated with a line represented by the plurality of data points.

At block 102, the index, k, is initialized to two, and a first multiplier value, N₁, is initialized to zero. At block 104, all possible values of N₂ are determined according to a known maximum value, Tₘₐₓ, and a known minimum value, Tₘᵢₙ, for T and the first two data points, t₁ and t₂. For example, a set of possible values for N₂, can include all of the integers in a range defined as follows:

$${N}_{2} ∈ [ \frac{{t}_{2} - {t}_{1}}{{T}_{max}} , \frac{{t}_{2} - {t}_{1}}{{T}_{min}} ] , {N}_{2} \neq 0 \qquad ( Eq . 6 )$$

At this point in the process, the set of possible values for N₂ can be conceptualized as a first branching for a decision tree representing a plurality of interim solutions to the greatest divisor problem. Each interim solution is represented by the multiplier values along one of a plurality of paths from a root of the decision tree to an associated terminal branch. The value of the first data point, t₁, can be utilized as a first estimation of the offset, \hat{T}_{d0}, for all values of N₂. The variance of the measurement error, σ², can be used as an estimate for a first estimate, σ_{Td0}²,of the variance of the offset estimate. A first estimation of the GCD, and accordingly the slope of the line represented by the data points, can be determined for each possible value of N₂ as:

$${\hat{T}}_{0} = \frac{{t}_{2} - {t}_{1}}{{N}_{2}} \qquad ( Eq . 7 )$$

A first estimate of the variance, σ_{T0}², of the slope estimate can be determined for each possible value of N₂ as:

$${σ}_{T 0}^{2} = \frac{2 {σ}^{2}}{{N}_{2}} \qquad ( Eq . 8 )$$

The index k is incremented by one at block 106. The interim solutions are updated at block 108 using a set of all possible values for Nₖ. This can be accomplished by selecting all integer values within a defined range, such that:

$${N}_{k} ∈ \frac{( \hat{T} ( {t}_{k} - {\hat{T}}_{d} ) \pm \sqrt{\begin{matrix}{( {t}_{k} - {\hat{T}}_{d} )}^{2} {\hat{T}}^{2} - ( {\hat{T}}^{2} - K {σ}_{T}^{2} ) \\ [ {( {t}_{k} - {\hat{T}}_{d} )}^{2} - K ( {σ}^{2} - {σ}_{Td}^{2} ) ]\end{matrix}} )}{( {\hat{T}}^{2} - K {σ}_{T}^{2} )} \qquad ( Eq . 9 )$$

where k is an index associated with the data points, tₖ is a k^{th} data point, Nₖ is an integer multiplier associated with the k^{th} data point, K is a (1−α) quantile value associated with a desired confidence value, (1−α) in a chi-squared distribution, σ² is the variance associated with the measurement error, \hat{T} is an estimate of a slope of a line represented by the data points, σ_{T}² is an estimated variance associated with the slope estimate, \hat{T}_{d} is an estimate of an offset value (e.g., y-intercept) of a line represented by the data points, and σ²_{T}_{^{d}} is an estimated variance associated with the y-intercept estimate.

For large data sets, it can be assumed that the variance of the slope σ_{T}² and the variance of the offset σ² _{T}_{^{d}} is roughly equal to the actual variance of the measurement errors, σ², and the calculation of the range simplifies to:

$${N}_{k} ∈ \frac{( {t}_{k} - {\hat{T}}_{d} ) \pm σ \sqrt{K}}{\hat{T}} \qquad ( Eq . 10 )$$

From the determined range, a new set of terminal branches associated with the possible values for the current multiplier value, Nₖ, can be appended onto the remaining branches of the decision tree. At block 110, an interim solution is selected from the available interim solutions.

At block 112, regression parameters can be calculated for the plurality of data points to estimate the GCD or a value associated with the GCD, and the offset value. The regression analysis can utilize the k ordered pairs, (Nₖ, tₖ), formed by the multipliers and data points that have been incorporated into the interim solutions. In an exemplary implementation, correction values, T′and T_{d}′, representing corrections for previously estimated slope and offset values, are determined to avoid large summed squared values that could reduce numerical precision of the calculation.

The regression parameters can be calculated as:

$$\begin{matrix}\{ \begin{matrix}{S}_{x} = {\sum }_{i = 1}^{k} {N}_{i} & Δ {t}_{i} = {t}_{i} - {N}_{i} {\hat{T}}_{0} - {\hat{T}}_{d 0} & {T}^{′} = \frac{k {S}_{xy} - {S}_{x} {S}_{y}}{D} \\ {S}_{xx} = {\sum }_{i = 1}^{k} {N}_{i}^{2} & {S}_{ xy} = {\sum }_{i = 1}^{ k} {N}_{ i} Δ {t}_{ i} & {T}_{d}^{′} = \frac{{S}_{xx} {S}_{y} - {S}_{x} {S}_{xy}}{D} \\ D = k {S}_{xx} - {( {S}_{x} )}^{2} & {S}_{yy} = {\sum }_{i = 1}^{k} Δ {t}_{i}^{2} & {σ}_{T}^{2} = \frac{{S}_{xx} {σ}^{2}}{D} \\ {S}_{y} = {\sum }_{i = 1}^{k} Δ {t}_{i} & k {E}^{2} = {S}_{yy} - {S}_{xy} ( {T}_{k - 1}^{′} - {T}_{k}^{ ′} ) - {S}_{y} [ {( {T}_{d}^{′} )}_{k - 1} - {( {T}_{d}^{′} )}_{k} ] & {σ}_{Td}^{2} = \frac{k {σ}^{2}}{D}\end{matrix} & ( Eq . 11 )\end{matrix}$$

where k is an index associated with the data points, tₖ is a k^{th} data point, Nₖ is an integer multiplier associated with the k^{th} data point, kE² is a summed squared error associated with the plurality of data points, σ² is the variance associated with the measurement error, \hat{T}₀ is a first estimate of a slope of a line represented by the data points, \hat{T}_{d0} is a first estimate of an offset value (e.g., y-intercept) for a line represented by the data points, T′ is a correction value representing a present estimate, \hat{T}, of the slope, such that \hat{T}=T′+\hat{T}₀, T_{d}′is a correction value representing a present estimate, \hat{T}_{d}, of the offset value, such that \hat{T}_{d}=T_{d}′+\hat{T}_{d0}, σ_{T}² is an estimated variance associated with the slope value estimate, and σ²_{T}_{^{d}} is an estimated variance associated with the offset value estimate.

The determined slope offset, T′, from the regression model allows an estimated GCD value to be determined for the interim solution, and the summed squared error, kE², provides an indication of the confidence in the solution. It will be appreciated that the statistics described above are well-suited to iterative updating, such that the processing demands of the methodology are reduced.

At decision block 114, it is determined if the selected interim solution represents a likely solution for the GCD and the constant offset. A test value equal to the ratio of the summed squared error, kE², for a given solution to the estimated variance of the measurement errors, σ², can be determined and compared to a chi-square distribution with (k−1) degrees of freedom. If the test value is determined to lie outside of a desired confidence interval within the chi-square distribution (N), the interim solution is eliminated from consideration at block 116. In terms of the decision tree model, the terminal branch associated with the interim solution is removed, and no further updates are applied to the branch. The methodology then advances to decision block 118.

If it is determined at block 114 that the test value lies within the desired confidence value of the chi-square distribution (Y), the methodology advances directly to decision block 118. At block 118, it is determined if all of the interim solutions have been evaluated. If not (N), the methodology returns to block 110 to select a new interim solution for evaluation. If all of the interim solutions have been evaluated (Y), the methodology advances to decision block 120, where it is determined if a termination event has occurred. For example, the termination event can include the achievement of a sufficiently small sum squared error, the elimination of all interim solutions but one, or the use of all available data points. If no termination event has occurred (N), the methodology returns to block 116 to increment the index, k, and update the remaining interim solutions in light of the new data point. If a termination event has occurred (Y), the remaining interim solution having the largest associated slope value, T, is selected at block 112 to provide the GCD and offset values for the model, and the methodology terminates.

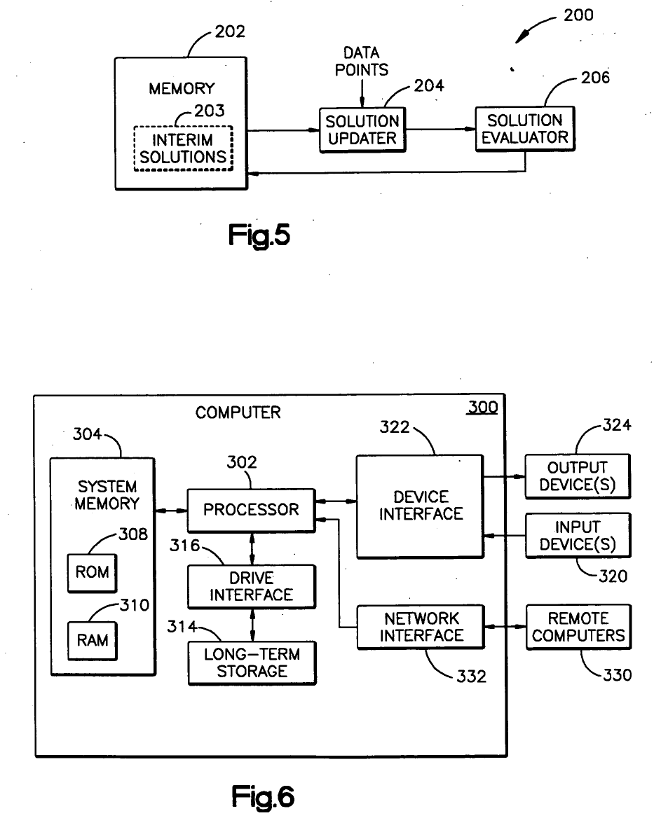

FIG. 5 illustrates an exemplary system 200 for determining the greatest common divisor (GCD) of a sequence of data points containing random error in accordance with an aspect of the present invention. The system attempts to find respective integer multipliers for the plurality of data points and determine the common divisor used to generate the data points. In one implementation, a common offset value can also be determined for the plurality of data points, such that a given data point can be represented as:
tₖ=NₖT+T_{d}+Wₖ (Eq. 12)

where k is an index associated with the data points, tₖ is a k^{th} data point, T is the greatest common divisor for the data set, T_{d} is a constant offset value, Nₖ is an integer multiplier associated with the k^{th} data point, and Wₖ is a random error from an Gaussian distribution having a mean of zero and a known variance σ².

The exemplary system 200 can be utilized in any situation in which it is useful to determine a GCD of a plurality of values that incorporate random noise. For example, the system 200 could be incorporated into a system for performing harmonic analysis on noisy data. In an exemplary implementation, the system 200 can be used in a Doppler emitter geolocation system to analyze a plurality of pulse times of arrival and calculate the period of a base clock used to generate the pulses.

It will be appreciated that the illustrated system 200 can be implemented as one or more computer programs, executable on one or more general purpose data processors. Accordingly, any structures herein described can be implemented alternately as dedicated hardware circuitry for the described function or as a program code stored as part of a computer-assessable memory, such as a computer hard drive, random access memory, or a removable disk medium (e.g., magnetic storage media, flash media, CD and DVD media, etc.). Functions carried out by the illustrated system, but not helpful in understanding the claimed invention, are omitted from this diagram.

The system 200 includes a memory 202 that stores an interim solution pool 203 that comprises a plurality of interim solutions to a given problem. Each interim solution includes a set of at least one integer multiplier value, with each multiplier value corresponding to one of the plurality of data points. An estimate of the GCD can be determined, for example, via a regression analysis or, in the case of a single value, simple division.

For each new data point provided to the system, the interim solutions can be updated at a solution updater 204. The solution updater 204 uses the new data point to provide a set of one or more new interim solutions from each existing interim solution. The solution updater 204 can determine, for a given existing interim solution, a plurality of possible multiplier values associated with the new data point. For example, the possible multiplier values can include all integers within a range defined by the data point and the estimate of the GCD associated with the existing interim solution. The set of new interim solutions for each existing interim solution includes a new interim solution incorporating each possible multiplier value.

The updated interim solutions are provided to a solution evaluator 206. The solution evaluator 206 evaluates each of the updated interim solutions to determine if it is likely that the interim solution represents an accurate representation of the data points and their associated GCD. For example, the multiplier values comprising the interim solution and the data points associated with the multiplier values can be subjected to a regression analysis to determine how well they fit an associated data model. An estimate of the GCD can be calculated for each updated interim solution according to the results of this analysis. Models that are determined to fit the model poorly, such that they have a low probability of providing an accurate GCD, can be eliminated from the pool of interim solutions 202. Accordingly, the pool of interim solutions 202 can be narrowed with each new data point to reduce the computational demands on the system 200. When all of the data points have been considered or the pool of interim solutions has been reduced to a single solution, a GCD can be calculated from one of the remaining solutions.

FIG. 6 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of a computer-aided engineering (CAE) tool running computer executable instructions to perform a method as described herein.

The computer system 300 includes a processor 302 and a system memory 304. A system bus 306 couples various system components, including the system memory 304, to the processor 302. Dual microprocessors and other multi-processor architectures can also be utilized as the processor 302. The system bus 306 can be implemented as any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) 312 can reside in the ROM 308, generally containing the basic routines that help to transfer information between elements within the computer system 300, such as a reset or power-up.

The computer system 300 can include a hard disk drive 314, a magnetic disk drive 316, e.g., to read from or write to a removable disk 318, and an optical disk drive 320, e.g., for reading a CD-ROM or DVD disk 322 or to read from or write to other optical media. The hard disk drive 314, magnetic disk drive 316, and optical disk drive 320 are connected to the system bus 306 by a hard disk drive interface 324, a magnetic disk drive interface 326, and an optical drive interface 334, respectively. The drives and their associated computer-readable media provide nonvolatile storage of data, data structures, and computer-executable instructions for the computer system 300. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like.

A number of program modules may also be stored in one or more of the drives as well as in the RAM 310, including an operating system 330, one or more application programs 332, other program modules 334, and program data 336.

A user may enter commands and information into the computer system 300 through user input device 340, such as a keyboard or a pointing device (e.g., a mouse). Other input devices may include a microphone, a joystick, a game pad, a scanner, a touch screen, or the like. These and other input devices are often connected to the processor 302 through a corresponding interface or bus 342 that is coupled to the system bus 306. Such input devices can alternatively be connected to the system bus 306 by other interfaces, such as a parallel port, a serial port or a universal serial bus (USB). One or more output device(s) 344, such as a visual display device or printer, can also be connected to the system bus 306 via an interface or adapter 346.

The computer system 300 may operate in a networked environment using logical connections 348 to one or more remote computers 350. The remote computer 348 may be a workstation, a computer system, a router, a peer device or other common network node, and typically includes many or all of the elements described relative to the computer system 300. The logical connections 348 can include a local area network (LAN) and a wide area network (WAN).

When used in a LAN networking environment, the computer system 300 can be connected to a local network through a network interface 352. When used in a WAN networking environment, the computer system 300 can include a modem (not shown), or can be connected to a communications server via a LAN. In a networked environment, application programs 332 and program data 336 depicted relative to the computer system 300, or portions thereof, may be stored in memory 354 of the remote computer 350.

1. A method for determining the greatest common divisor (GCD) for a plurality of data points comprising:
generating a plurality of interim solutions from an initial set of at least one data point from the plurality of data points; and
iteratively performing the following steps until the occurrence of a termination event:
selecting a new data point from the plurality of data points;
updating each of the plurality of interim solutions according to the selected data point, as to provide a set of at least one updated interim solution from each interim solution;
evaluating each updated interim solution to produce a fitness parameter; and
eliminating an updated interim solution when the fitness parameter does not achieve a desired threshold.

2. A method as set forth in claim 1, wherein the step of generating a plurality of interim solutions from an initial set of at least one data point includes generating an interim solution corresponding to each integer within a defined range.

3. A method as set forth in claim 1, wherein the step of updating each of the plurality of solutions comprises the steps of:
selecting a current interim solution from the plurality of interim solutions, the current interim solution comprising at least one associated multiplier value;
defining a range of possible multiplier values for the selected data point according to a previous estimate of the GCD and the selected data point;
identifying at least one integer within the defined range; and
generating an updated interim solution for each identified integer, a given updated interim solution comprising the at least one multiplier value associated with the current interim solution and an identified integer.

4. A method as set forth in claim 1, wherein the step of evaluating each updated interim solution comprises conducting a regression analysis on a set of multiplier values comprising a given interim solution and the plurality of data points.

5. A method as set forth in claim 4, wherein the fitness parameter comprises a sum squared error parameter calculated as part of the regression analysis.

6. A method as set forth in claim 1, wherein the step of eliminating an updated interim solution when the fitness parameter does not achieve a desired threshold comprises computing a test value from the fitness parameter and comparing the test value to a chi-squared distribution.

7. A system for determining a greatest common divisor (GCD) for a plurality of numerical data points comprising:
a system memory that stores a pool of at least one interim solution;
a solution updater that updates the pool of interim solutions according to a received data point to produce at least one updated interim solution; and
a solution evaluator that evaluates each updated interim solution, calculates an estimated GCD for each of the plurality of solutions, and eliminates an updated interim solution when the likelihood that the estimated GCD associated with the interim solution is correct falls below a threshold value.

8. A system as set forth in claim 7, the solution updater being operative to retrieve an interim solution from the system memory, calculate at least one integer multiplier value from the received data point and a previous estimate of the GCD associated with the retrieved solution, and produce a corresponding set of at least one updated interim solution from the retrieved interim solution.

9. A system as set forth in claim 8, wherein a given updated interim solutions comprise an associated integer multiplier value from the calculated at least one integer multiplier value and a set of at least one multiplier value associated with the retrieved interim solution.

10. A system as set forth in claim 7, the solution evaluator being operative to determine a fitness parameter for a given updated interim solution, representing the likelihood that the estimated GCD associated with the interim solution is the correct GCD for the plurality of numerical data points.

11. A system as set forth in claim 7, wherein the solution evaluator is operative to perform a regression analysis on the plurality of data points and a set of multiplier values comprising a given interim solution.

12. An emission geolocation system comprising the system of claim 7.

13. A computer program product, encoded on a computer readable medium and operative in a computer processor, for determining a greatest common divisor (GCD) for a plurality of numerical data points comprising:
a system memory that stores a pool of interim solutions;
a solution updater that receives a given data point from the plurality of numerical data points and updates the pool of interim solutions according to the received data point; and
a solution evaluator that evaluates each updated interim solution to produce a fitness parameter and eliminates an updated interim solution when the fitness parameter does not meet a desired threshold.

14. A Doppler emitter geolocation system comprising the computer program product of claim 13.

15. A computer program product as set forth in claim 13, the solution updater being operative to retrieve an interim solution from the system memory, calculate at least one integer multiplier value from the received data point and produce a corresponding set of at least one updated interim solution from the retrieved interim solution.

16. A computer program product as set forth in claim 15, wherein each of the updated interim solutions comprise an associated integer multiplier value from the calculated at least one integer multiplier value and a set of at least one multiplier value associated with the retrieved interim solution.

17. A computer program product as set forth in claim 13, wherein the solution evaluator is operative to perform a regression analysis on the plurality of data points and a set of multiplier values comprising a given interim solution.

18. A computer program product as set forth in claim 17, wherein the solution evaluator is operative to iteratively update a plurality of regression parameters associated with the regression analysis each time a numerical data point from the plurality of numerical data points is received.

19. A computer program product as set forth in claim 13, wherein the solution evaluator is operative to compute a test value associated with an updated interim solution and eliminate the updated interim solution if the test value falls outside a confidence interval associated with a chi-squared distribution.

20. A computer program product as set forth in claim 13, wherein the solution evaluator is operative to calculate an estimated GCD for each updated interim solution.
